(19) United States
(12) Patent Application Publication
(10) Pub. No.: US 2002/0073315 A1
(43) Pub. Date: Jun. 13, 2002

(54) Placing a cryptogram on the magnetic stripe of a personal transaction card

(76) Inventor: Brant Candelore, Escondido, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/931,821

(22) Filed: Aug. 16, 2001

Related U.S. Application Data
(60) Provisional application No. 60/254,326, filed on Dec. 8, 2000.

(51) Int. Cl. H04L 9/00; H04K 1/00

(52) U.S. Cl. 713/172; 705/65

(57) ABSTRACT

A cryptogram is placed on a magnetic stripe of a personal transaction card after a user takes possession of the card. A device calculates a cryptogram based upon security information. A writer, coupled to the device, writes the cryptogram on the magnetic stripe of the personal transaction card to enhance security of the card.

### RELATED APPLICATIONS

This application claims the benefit of U.S. Provisional Application Serial No. 60/254,326 filed on Dec. 8, 2000. The provisional application is hereby incorporated by reference into the present application.

### BACKGROUND OF THE INVENTION

1. Field of the Invention

The present invention relates to personal transaction card security generally and to the use of a cryptogram in particular.

2. Art Background

Bankcards are used to perform a variety of business transactions that range from banking to purchases of goods and services via telephone. Typically point of sale (POS) terminals are read only devices. These POS terminals are set up to read a magnetic stripe on the back of a bankcard when the bankcard is presented for payment during a transaction. The magnetic stripe contains much of the same information as embossed on the front of the bankcard.

The embossed data is the raised plastic lettering that typically contains the following information; account number, “valid from” date; “good thru” date; and account holder name. In addition the magnetic stripe typically contains a cryptographic number often referred to as a cryptogram. This “static” cryptogram is read along with the other data on the magnetic stripe. The cryptogram is typically used to determine “Card Present” status within the POS terminal. The bankcard may also have printed card information as well. Printed card information might include: “issuing bank;” loyalty affiliations (e.g. Frequent Flyer Plan); and loyalty affiliation account number.

The magnetic stripe information on the bankcards may be easily read and fraudulent bankcards may be cloned with this information. The magnetic stripe information does not change during the useful life of the bankcard. The bankcard data may be used with telephone orders and bankcards are typically used to pay for meals in restaurants. It is easy for a sales clerk or waiter in a restaurant to make a copy of the bankcard information and then use it for a fraudulent purpose. Bankcard information may also be picked out of the trash and misappropriated for a fraudulent use.

One prior art attempt at solving this problem is the introduction of microprocessor-based smart cards. The introduction of microprocessor based smart cards has not gained much acceptance because of the existing magnetic stripe infrastructure. The magnetic stripe reader within a typical POS terminal cannot write data to the magnetic stripe. This deficiency, in the presently deployed POS terminals, makes it difficult to implement a challenge and response protocol, which would raise the level of bankcard security.

What is needed is a security system that prevents the fraudulent use of bankcard information that is compatible with the existing infrastructure of POS terminals.

### SUMMARY OF THE INVENTION

A cryptogram is placed on a magnetic stripe of a personal transaction card after a user takes possession of the card. A device calculates a cryptogram based upon security information. A writer, coupled to the device, writes the cryptogram on the magnetic stripe of the personal transaction card to enhance security of the card.

### DESCRIPTION OF THE DRAWINGS

The present invention is illustrated by way of example and not limitation in the figures of the accompanying drawings in which like references indicate similar elements. The objects, features and advantages of the present invention will be apparent from the following detailed description in which:

FIG. 1 is an example of a front and back of a personal transaction card.

FIG. 2 is a representation of one embodiment for the data fields on a magnetic stripe of a personal transaction card.

FIG. 3a is a representation of a front-view of one embodiment of a device for writing cryptograms.

FIG. 3b is a representation of a side view for one embodiment of a slot within the device of FIG. 3a containing a magnetic stripe writer.

FIG. 4 is a side view of one embodiment of direction of card travel through the slot of FIG. 3b.

FIG. 5 is a block diagram of one embodiment of a magnetic stripe writer system.

FIG. 6 is a block diagram of another embodiment of a magnetic stripe writer system.

FIG. 7 is a flow diagram of one embodiment of a method that writes a cryptogram to the magnetic stripe of a personal transaction card.

FIG. 8 is a flow diagram of another embodiment of a method that writes a cryptogram to the magnetic stripe of a personal transaction card.

FIG. 9 is a simplified block diagram of one embodiment of a secure transaction system.

FIG. 10 is a simplified block diagram of one embodiment of a privacy card for a personal transaction device.

FIG. 11 is a simplified block diagram of one embodiment of a digital wallet for a personal transaction device.

### DESCRIPTION

A cryptogram is placed on a magnetic stripe of a personal transaction card after a user takes possession of the card. A device calculates a cryptogram based upon security information. A writer, coupled to the device, writes the cryptogram on the magnetic stripe of the personal transaction card to enhance security of the card.

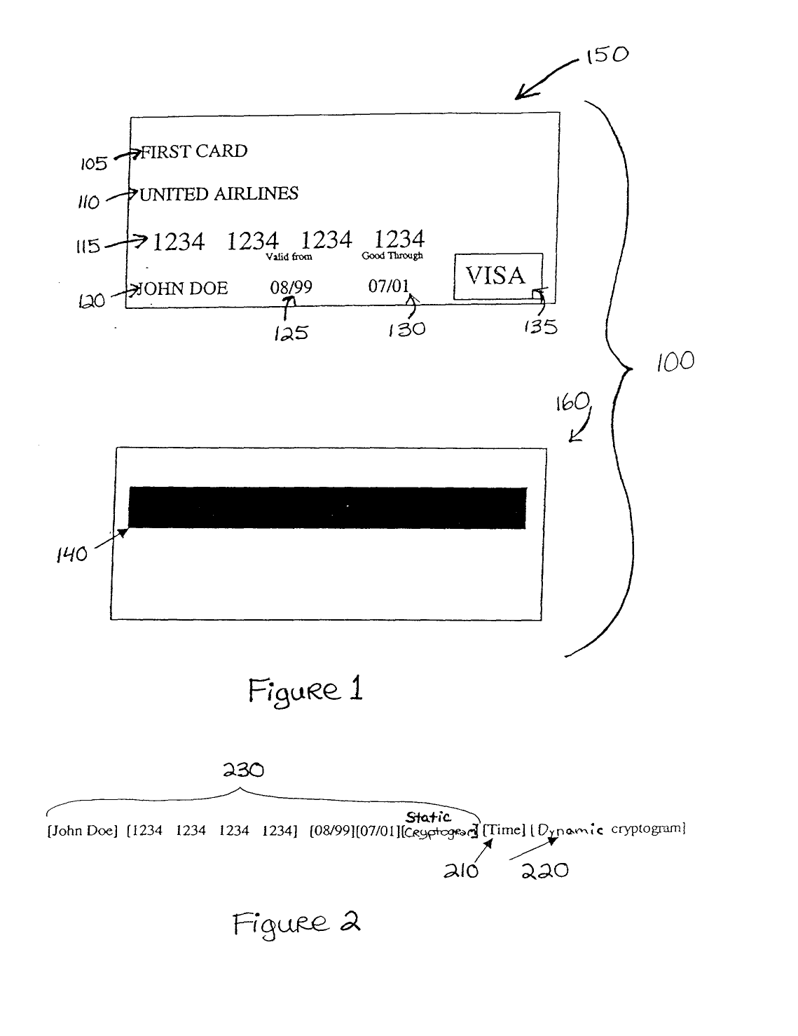

In the following descriptions for the purposes of explanation, numerous details are set forth in order to provide a thorough understanding of the present invention. However, it will be apparent to one skilled in the art that these specific details are not required in order to practice the present invention. In other instances, well known electrical structures or circuits are shown in block diagram form in order not to obscure the present invention unnecessarily. In FIGS. 1-6, identically numbered blocks represent similar elements and perform similar functions.

A device, such as a personal transaction device, may be used with a personal transaction card to create a security system that prevents fraudulent use of the personal transaction card. A personal transaction card may be a bankcard with a magnetic stripe. A personal transaction card may also be a credit card, debit card, loyalty card or other type of card containing a magnetic stripe. In one embodiment, the security system is initiated after a user authorizes the device for use and an output of a cryptographic process is written onto the personal transaction card by the device.

Various cryptographic processes may be employed that will result in a variety of different outputs. The output of the cryptographic process may be referred to by a variety of terms that are well known in the art such as an encryption, or a cryptogram. The invention is limited by the type of cryptographic process performed or the form of the output of the cryptographic process described herein. For instance, in one embodiment, the cryptographic process produces a hash from information on the personal transaction card. In another embodiment, the cryptogram is time-based, i.e. it uses a current time from a secure time source to generate a temporary cryptogram. Such a time-based cryptogram may be cancelled at the expiration of a time period. In another embodiment the cryptographic process produces an encrypted hash with the use of a key. Encryption may be performed symmetrically where a key used for decryption may be ascertained from a key used for encryption and vice versa. Alternatively, the encryption may be asymmetric, where the key used for encryption is different from the key used for decryption. Asymmetric encryption is also characterized by the fact that a decryption key cannot be calculated (at least in a reasonable amount of time) from an encryption key.

In addition to the information on the personal transaction card the cryptographic process may use one or more additional pieces of information. A non-exhaustive list of some examples of such additional pieces of information includes: time; user input information such as a personal identification number (PIN); biometric data such as a fingerprint; a DNA sample; acoustic data from a user; such as a voice sample or data from the device such as a globally unique silicon ID (GUID). The information used to create the cryptogram is referred to as security information.

FIG. 1 is an example of a front and back of a personal transaction card (PTC) 100. Referring to card front 150, the personal transaction card 100 includes various elements of card information. Card issuer 105 indicates a name for a bank or other institution that issued the card 100. Loyalty affiliation 110 indicates a cardholder's affiliation with a group or organization. Account number 115 indicates an account number associated with the card 100. Cardholder name 120 indicates the name of the person to whom the card 100 was issued. Valid from date 125 indicates the date from which the card may begin to be used. Valid through date 130 indicates the date at which the card expires. Card type 135 indicates the card payment services organization. (First Card™ is a registered trademark of First Card Corporation. United Airlines™ is a registered trademark of United Airlines Corporation. Visa™ is a registered trademark of Visa Corporation.)

Referring to card back 160, the back of a personal transaction card includes a magnetic stripe 140 containing existing PTC information. The magnetic stripe is designed as a two-way data interchange interface, and thus is capable of receiving new data. Magnetic stripe 140 is readable by a magnetic stripe reader and writeable by a magnetic stripe writer.

In one embodiment, a cardholder swipes his PTC 100 through a device for writing a cryptogram onto a magnetic stripe 140 and security information 230 is read from the magnetic stripe 140. The device for writing a cryptogram uses the security information 230 to calculate the cryptogram 220. The device writes the cryptogram 220 to the magnetic stripe 140. The PTC 100 may be read at existing read-only Point of Sale (POS) terminals. The writer may also place the transaction amount and other information, such as biometric information, on the magnetic stripe 140 for later verification at a transaction terminal.

In an alternate embodiment, the static cryptogram already present on the magnetic stripe 140 may be replaced with the dynamic cryptogram 220. The terms cryptogram and dynamic cryptogram will be used interchangeably.

In one embodiment, a reader obtains security information 230 from a personal transaction card 100 by reading its magnetic stripe 140.

FIG. 2 is a representation of one embodiment for the data fields on magnetic stripe 140 after the dynamic cryptogram 220 has been added. Time field 210 is a stamp of the current time at the time of swiping the personal transaction card 100 through a magnetic stripe writer. In one embodiment, data fields on the magnetic stripe 140 contain similar data 230 as embossed on card front 150 with the addition of the cryptogram or “dynamic” cryptogram 220, such as a time-based cryptogram. This cryptogram is in addition to a static cryptogram within existing magnetic stripe information 230. Existing magnetic stripe information 230 also includes name, account number, duties of validity, and a static cryptogram. In an alternate embodiment, a current time field 210, stating the time at the moment of cryptogram calculation, may be added to a magnetic stripe 140. In another embodiment, additional identifying information may be placed on the magnetic stripe 140, such as for example a purchase item identifier. A purchase item identifier identifies an item as being one for which a purchase has been authorized.

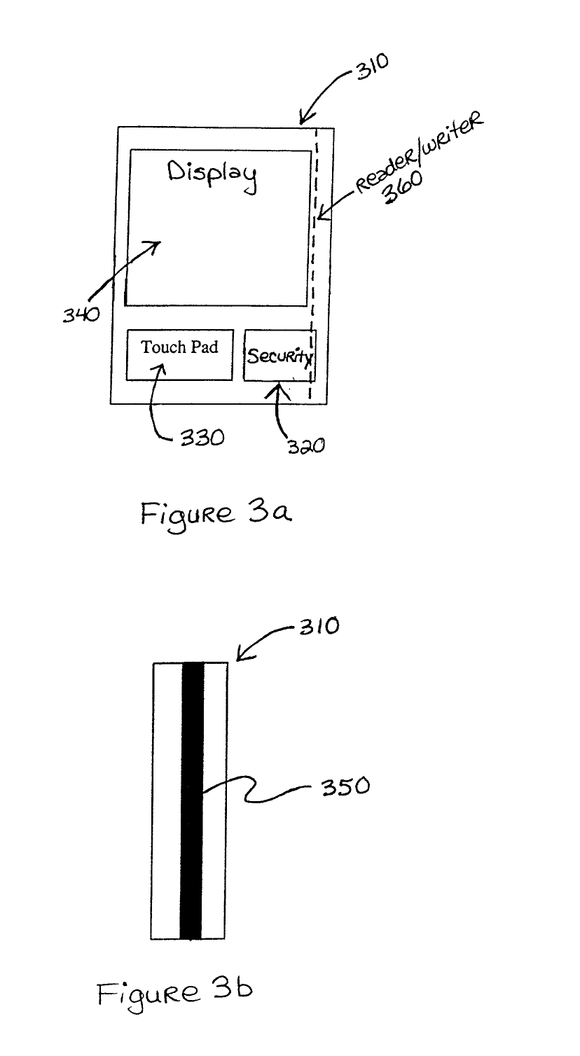

FIG. 3a is a representation of a front view of one embodiment for a device 310 for writing a cryptogram onto magnetic stripe 140. In one embodiment, a magnetic stripe reader/writer 360 may be included in the device 310. Device 310 includes a security device 320. Security device 320 can be a biometric security device, such as a fingerprint scanner, retinal scanner or other similar device. In another embodiment, the security device 320 may be a keypad for entering a personal identification number (PIN) code. Referring again to FIG. 3a, device 310 may also include touch pad 330 for inputting data into device 310. Display 340 provides for user/system interface. Display 340 may be any suitable display such as, for example, a liquid crystal display [LCD].

FIG. 3b is a representation of a side view for one embodiment of a slot 350 within device 310 that gives access to the magnetic stripe reader/writer 360. Slot 350 is suitable to receive a personal transaction card 100 for magnetic stripe read and write operations. A “swipe” is an action of sliding a PTC 100 through a device 310, such as for example, through slot 350.

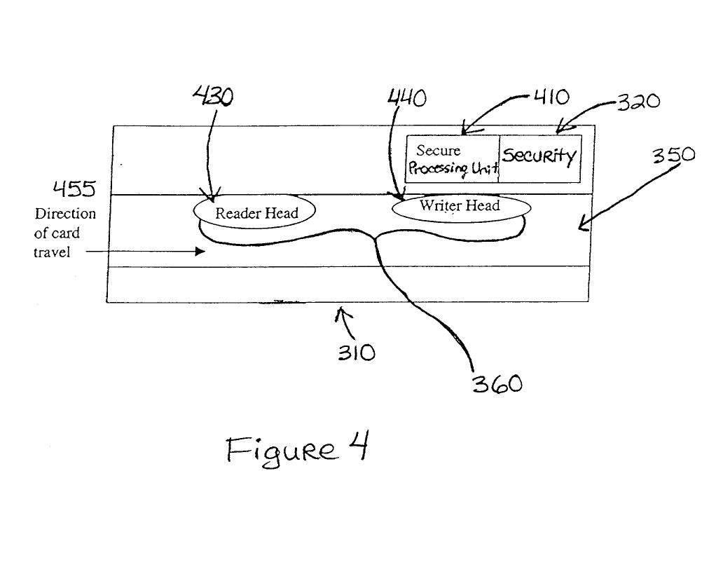

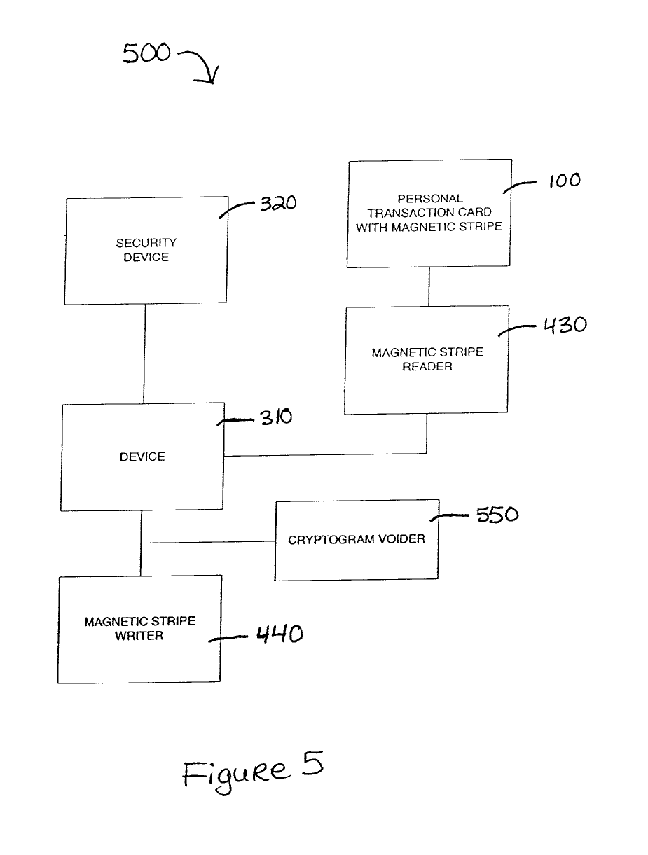

FIG. 4 is a side view of the direction of card travel through the device 310. In one embodiment, PCT 100 may be swiped through slot 350 of device 310. In one embodiment, device 310 includes secure processing unit 410 for calculating the cryptogram 220. In another, embodiment, magnetic stripe reader/writer 360 includes reader head 430 and writer head 440. During a PTC swipe operation, reader head 430 reads magnetic stripe 140 as the card passes through slot 350 in the direction of card travel 455. Cryptogram 220 may be calculated using security information 230 contained on magnetic stripe 140 or other security information such as, for example, a personal identification number (PIN) code or other similar information. Cryptogram 220 may be calculated in a secure processing unit 410 or in some other component of device 310. Writer head 440 places the cryptogram 220 on magnetic stripe 140.

In one embodiment, if cryptogram 220 cannot be written with a single swipe of PTC 100, then the user is asked to re-swipe the PTC 100. In this embodiment, cryptogram 220 is written onto magnetic stripe 140 on the second swipe. In another embodiment, a message is displayed on the display 340 to confirm the writing of cryptogram 220. In yet another embodiment, PTC 100 may be swiped a third time to allow device 310 or secure processing unit 410 of the device 310 to verify that cryptogram 220 was written onto a magnetic stripe 140. A message confirming that the cryptogram 220 has been written to magnetic stripe 140 may be displayed on display 340.

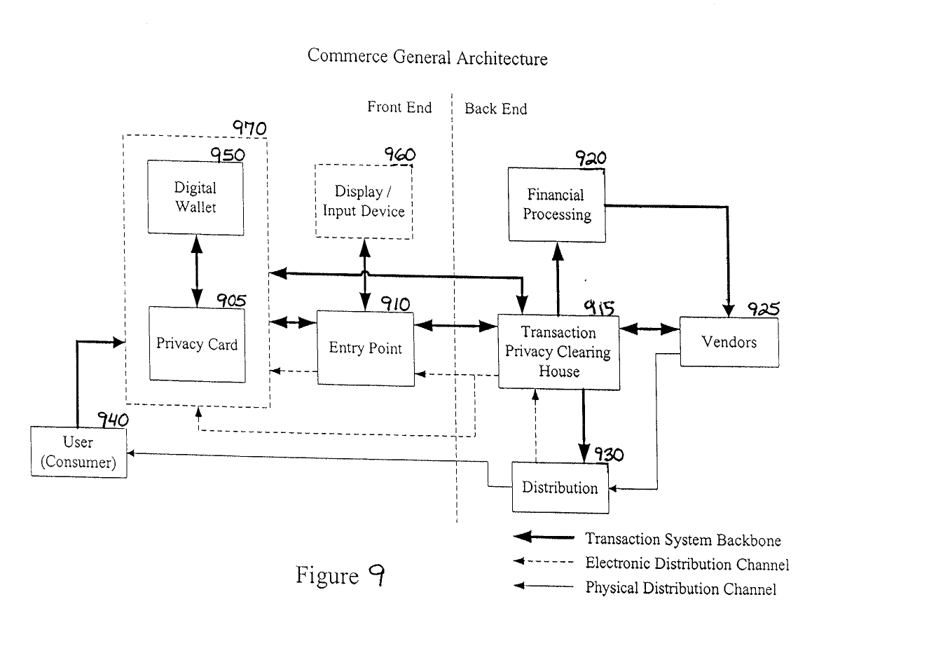

In one embodiment, a Point of Sale (POS) terminal reads PTC 100 after it has been swiped. The POS terminal reads cryptogram 220 together with existing PTC information 230. The POS terminal verifies the purchase based upon the cryptogram 220. The verification of cryptogram 220 may take place through the execution of two cryptographic processes, one in the device 310 and the other in an independent cryptogram verification source (ICVS), such as a transaction privacy clearing house (TPCH) described further below in conjunction with FIG. 9. For example, an input to a first cryptographic process could be a user account number from existing PTC information 230. Device 310 may be configured to produce an encrypted hash (cryptogram 220) as the output to the first cryptographic process. An ICVS could perform a decryption during a second cryptographic process that would produce as the output, the user account number. In this example, the output of the second cryptographic process (user account number) is compared against the input to the first cryptographic process (user account number) by the ICVS to either allow or deny the transaction. Many other verification schemes are also applicable and are contemplated as within the scope of the invention.

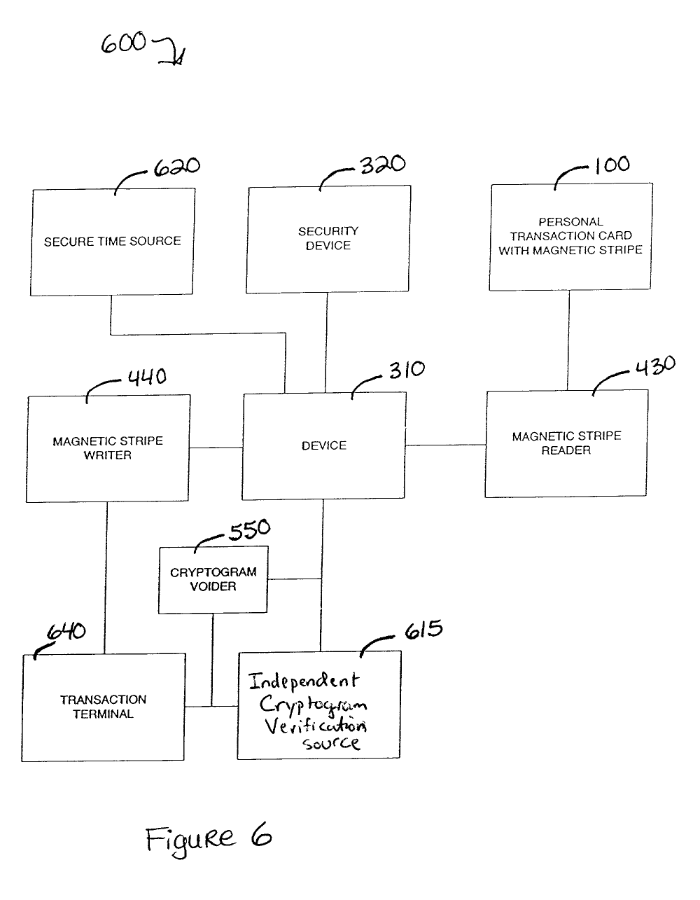

FIG. 5 is a block diagram of one embodiment for a magnetic stripe reader/writer system 500. Referring to FIG. 5, security device 320 may be used to unlock device 310 for use by an authorized user. In one embodiment, the security device 320 may only allow one person, i.e. the owner of the device 310, to gain access to device 310. In another embodiment, security device 320 allows other persons to use device 310, such as family members. In yet another embodiment, security device 320 may be used to place a restriction upon a user. For example, “daughter Sandra may only spend $100”, or “son Bob may only spend money on food”.

Magnetic stripe reader 430 reads information 230, i.e. security information, from PTC 100. Device 310 receives the information 230 and calculates cryptogram 220. Magnetic stripe writer 440 places cryptogram 220 onto magnetic stripe 140. In one embodiment, cryptogram voiding mechanism (“voider”) 550 invalidates cryptogram 220 upon expiration of a time period. To void cryptogram 220, cryptogram voider 550 may remove cryptographic information from a memory used for validation. Alternately, cryptogram 220 may expire at a certain time.

In another embodiment, magnetic stripe writer 440 is externally located from device 310. A cryptogram 220 can be calculated in the device 310 and cryptogram 220 may be communicated to a transaction terminal 640 such as for example, a point of sale terminal. The cryptogram 220 may be written to PTC 100 with magnetic stripe writer 440 embodied in or coupled to transaction terminal 640. The PTC 100 with cryptogram 220 can then be used for a transaction.

FIG. 6 is a block diagram of another embodiment of a magnetic stripe writer system 600. ICVS 615 may be coupled selectively to device 310 when a transaction is to be performed. In one embodiment, ICVS 615 may authorize a transaction based upon verification of cryptogram 220. In another embodiment, ICVS 615 provides an algorithm or other data to device 310 to be used in calculating cryptogram 220. In yet another embodiment, ICVS 615 is coupled selectively to transaction terminal 640. Transaction terminal 640 may communicate with ICVS 615 and device 310 to authorize a transaction. Transaction terminal 640 may be a point of sale (POS) terminal, a home computer system, an automatic teller machine (ATM), a digital television or other type of terminal. Magnetic stripe writer 430 places cryptogram 220 onto magnetic stripe 140. In one embodiment, a secure time source 620 provides a current time to device 310 for calculating a time-based cryptogram. In one embodiment, secure time source 620 is an access path to a secure time server.

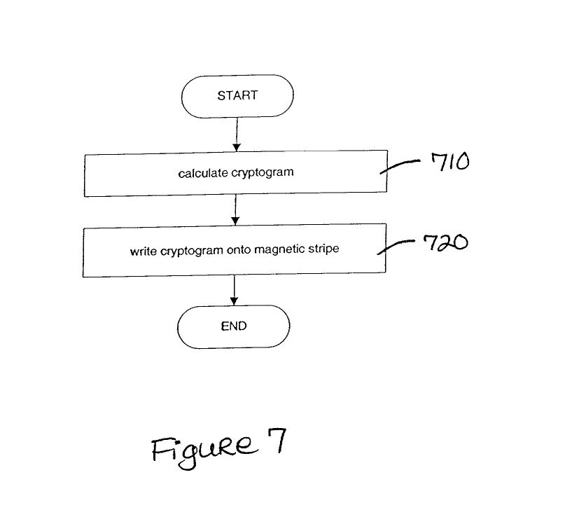

FIG. 7 is a flow diagram of an embodiment of a method executed by the device 310 to write a cryptogram to the magnetic stripe of a personal transaction card. At block 710, the cryptogram is calculated from security information. Security information may include existing PTC information. At block 720, the cryptogram is written into the magnetic stripe of the PTC.

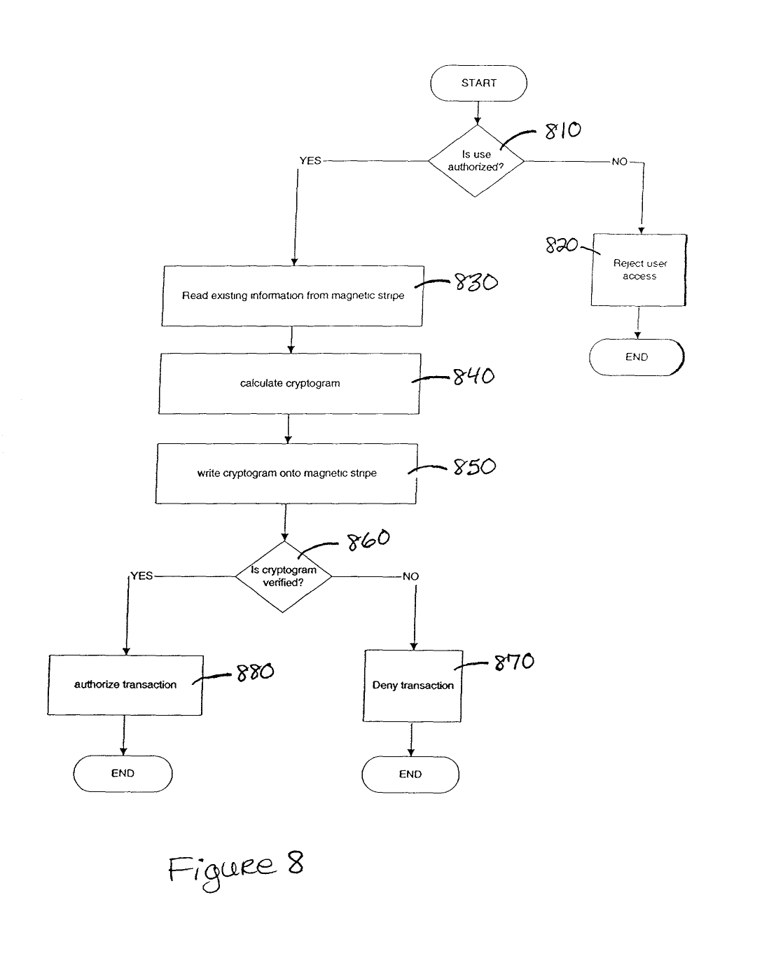

FIG. 8 is a flow diagram of another embodiment for writing a cryptogram to the magnetic stripe of a personal transaction card. At block 810, the authorization of the user to access a device with magnetic stripe writer is checked by the security device. At block 820, the user is rejected access if the user is not authorized. At block 830, existing information is read from the magnetic stripe of a PTC if the user is authorized. At block 840, a cryptogram is calculated using the existing PTC information. At block 850, the cryptogram is written to the magnetic stripe. At block 860, the cryptogram is verified against an independent cryptogram verification source. At block 870, the transaction is denied if the cryptogram is not verified. At block 880, the transaction is authorized if the cryptogram is verified.

FIG. 9 is a block diagram of one embodiment of a secure transaction system, which may be used in electronic commerce. In this embodiment, transaction privacy clearing house (TPCH) 915 interfaces a user (consumer) 940 and a vendor 925. In this particular embodiment, a personal transaction device (PTD) 970, e.g., a privacy card 905, or a privacy card 905 coupled to a digital wallet 950, is used to maintain the privacy of the user while enabling the user to perform transactions. In an alternate embodiment, the PTD 970 may be any suitable device that allows unrestricted access to TPCH 915. The personal transaction device information is provided to the TPCH 915 that then indicates to the vendor 925 and the user 940 approval of the transaction to be performed.

In order to maintain confidentiality of the identity of the user 940, the transaction device information does not provide user identification information. Thus, the vendor 925 or other entities do not have user information but rather transaction device information. The TPCH 915 maintains a secure database of transaction device information and user information. In one embodiment, the TPCH 915 interfaces to at least one financial processing system 920 to perform associated fmancial transactions, such as confirming sufficient funds to perform the transaction, and transfers to the vendor 925 the fees required to complete the transaction. In addition, the TPCH 915 may also provide information through a distribution system 930 that, in one embodiment, can provide a purchased product to the user 940, again without the vendor 925 knowing the identification of the user 940. In an alternate embodiment, the financial processing system 920 need not be a separate entity but may be incorporated with other functionality. For example, in one embodiment, the financial processing system 920 may be combined with the TPCH 915 functionality.

In one embodiment, the financial processing system (FP) 920 performs tasks of transferring funds between the user's account and the vendor's account for each transaction. In one embodiment, the presence of the TPCH 915 means that no details of the transactions, other than the amount of the transactions and other basic information, are known to the FP 920. The TPCH 915 issues transaction authorizations to the FP 920 function on an anonymous basis on behalf of the user over a highly secure channel. The FP 920 does not need to have many electronic channels receiving requests for fund transfer, as in a traditional financial processing system. In one embodiment, a highly secure channel is set up between the TPCH 915 and the FP 920; thus, the FP 920 is less vulnerable to spoofing.

In one embodiment, the FP 920 is contacted by the TPCH 915 requesting a generic credit approval of a particular account. Thus the FP 920 receives a minimal amount of information. In one embodiment, the transaction information, including the identification of goods being purchased with the credit need not be passed to the FP 920. The TPCH 915 can request the credit using a dummy charge ID that can be listed in the monthly credit statement sent to the user, so that the user can reconcile his credit statement. Further, the personal transaction device 905 can include functionality to cause the credit statement to convert the dummy charge ID back to the transactional information so that the credit statement appears to be a conventional statement that lists the goods that were purchased and the associated amount charged.

A display input device 960 (shown in phantom) may be included to enable the user, or in some embodiments the vendor 925, to display status and provide input regarding the PTD 905 and the status of the transaction to be performed.

In yet another embodiment, an entry point 910 interfaces with the personal transaction device 970 and also communicates with the TPCH 915. The entry point 910 may be an existing (referred to herein as a legacy POS terminal) or a newly configured point of sale (POS) terminal located in a retail environment. The user 940 uses the PTD 970 to interface to the POS terminal in a manner similar to how credit cards and debit cards interface with POS terminals. The entry point 910 may also be a public kiosk, a personal computer, or the like.

The system described herein also provides a distribution functionality 930 whereby products purchased via the system are distributed. In one embodiment, the distribution function 930 is integrated with the TPCH 915 functionality. In an alternate embodiment, the distribution function 930 may be handled by a third party. Utilizing either approach, the system ensures user privacy and data security. The distribution function 930 interacts with the user through PTD 930 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 970 to change the shipping address of the product at any time during the distribution cycle.

A user connects to and performs transactions with a secure transaction system (such as shown in FIG. 9) through a device 310 that has a unique identifier (ID). In one embodiment, the reader/writer system may include a device identifier that provides no apparent identification of a user authorized to use the device. The system may also have a communication logic configured to communicate the device identifier and a cryptogram to an electronic commerce system to perform a transaction. The electronic commerce system may comprise a secure mechanism for correlating the cryptogram, device identifier and a user. In one embodiment, transaction terminal 640, device 310 and the TPCH 915 are configured to verify each other as legitimate. The system may further include a transaction history storage area configured to store transaction records. The device 310 may be a personal transaction device (PTD). In one embodiment, a privacy card is used. In an alternate embodiment a digital wallet is used. In yet another alternate embodiment, a privacy card in conjunction with a digital wallet is used.

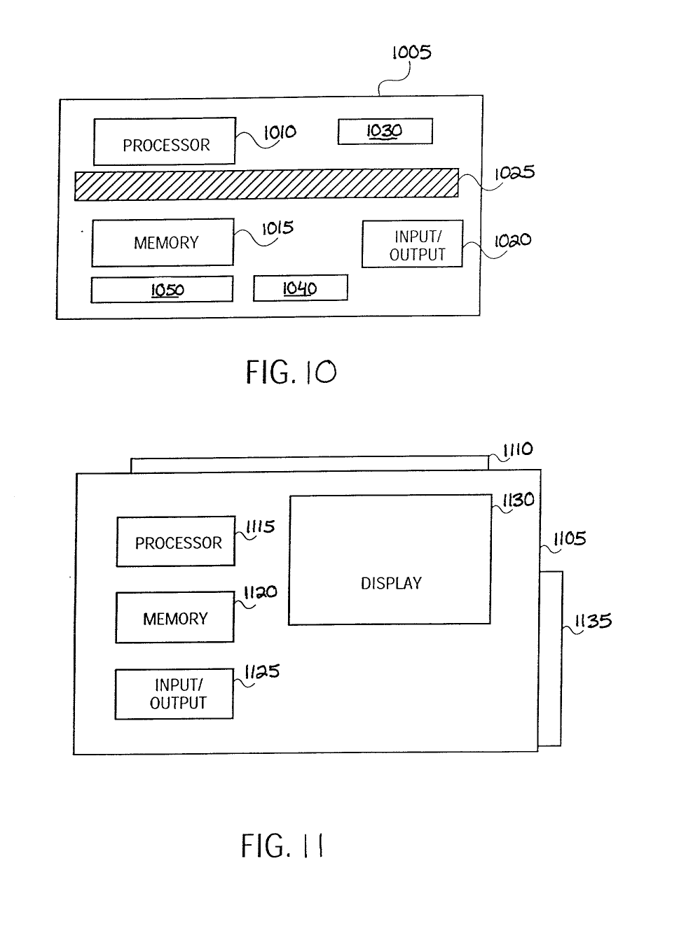

One embodiment of a privacy card 1005 is illustrated in FIG. 10. In one embodiment, the card 1005 is configured to be the size of a credit card. The privacy card includes a processor 1010, memory 1015 and input/output logic 1020. The processor 1010 is configured to execute instructions to perform the functionality herein. The instructions may be stored in the memory 1015. The memory is also configured to store data, such as transaction data and the like. In one embodiment, the memory 1015 stores the transaction ID used to perform transactions in accordance with the teachings of the present invention. Alternately, the processor may be replaced with specially configured logic to perform the functions described here.

The input/output logic 1020 is configured to enable the privacy card 1005 to send and receive information. In one embodiment, the input/output logic 1020 is configured to communicate through a wired or contact connection. In another embodiment, the logic 1020 is configured to communicate through a wireless or contactless connection. A variety of communication technologies may be used.

In one embodiment, a display 1025 is used to generate bar codes scanable by coupled devices and used to perform processes as described herein. The privacy card 1005 may also include a magnetic stripe generator 1040 to simulate a magnetic stripe readable by devices such as legacy POS terminals.

In one embodiment, biometric information, such as fingerprint recognition, is used as a security mechanism that limits access to the card 1005 to authorized users. A fingerprint touch pad and associated logic 1030 is therefore included in one embodiment to perform these functions. Alternately, security may be achieved using a smart card chip interface 1050, which uses known smart card technology to perform the function.

Memory 1015 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 1015 can also have user identity/account information block. The user identity/account information block stores data about the user and accounts that are accessed by the card. The type of data stored includes the meta account information used to identify the account to be used.

One embodiment of a digital wallet 1105 is illustrated in FIG. 11. The digital wallet 1105 includes a coupling input 1110 for the privacy card 1005, processor 1115, memory 1120, input/output logic 1125, display 1130 and peripheral port 1135. The processor 1115 is configured to execute instructions, such as those stored in memory 1120, to perform the functionality described herein. Memory 1120 may also store data including financial information, eCoupons, shopping lists and the like. The digital wallet may be configured to have additional storage. In one embodiment, the additional storage is in a form of a card that couples to the device through peripheral port 1110.

In one embodiment, the privacy card 1005 couples to the digital wallet 1105 through port 1110; however, the privacy card 1005 may also couple to the digital wallet 1105 through another form of connection including a wireless connection.

Input/output logic 1125 provides the mechanism for the digital wallet 1105 to communicate information. In one embodiment, the input/output logic 1125 provides data to a point-of-sale terminal or to the privacy card 1005 in a pre-specified format. The data may be output through a wired or wireless connection.

The digital wallet 1105 may also include a display 1130 for display of status information to the user. The display 1130 may also provide requests for input and may be a touch sensitive display, enabling the user to provide the input through the display.

The physical manifestation of many of the technologies in the digital wallet 1105 will likely be different from those in the privacy card 1005, mainly because of the availability of physical real estate in which to package technology. Examples of different physical representations would include the display, fingerprint recognition unit, etc.

The components of a secure transaction system illustrated in FIGS. 9, 10, and 11 are further described in PCT published patent application number US00/35619, which is assigned to the same assignee as the present application and which is hereby incorporated by reference.

It will be appreciated that the methods described in conjunction with FIGS. 7 and 8 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

It will be further appreciated that the instructions represented by the blocks in FIGS. 7 & 8 are not required to be performed in the order illustrated, and that all the processing represented by the blocks may not be necessary to practice the invention.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

The invention has been described in conjunction with the preferred embodiment. It is evident that numerous alternatives, modifications, variations and uses will be apparent to those skilled in the art in light of the foregoing description.

What is claimed is:

1. A method comprising:
calculating a cryptogram based upon security information; and
writing the cryptogram on a magnetic stripe of a personal transaction card after a user takes possession of the card.

2. The method of claim 1, further comprising reading the security information from the magnetic stripe of the personal transaction card.

3. The method of claim 1, further comprising verifying the cryptogram by comparing it against a cryptogram generated by an independent cryptogram verification source (ICVS).

4. The method of claim 3, further comprising authorizing a transaction based upon the verifying of the cryptogram.

5. The method of claim 3, wherein the independent cryptogram verification source is a transaction privacy clearing house (TPCH).

6. The method of claim 1, wherein the security information is selected from the group consisting of:
biometric information;
an existing data on the magnetic stripe;
a transaction amount; and
a personal identification number (PIN) code.

7. The method of claim 1, further comprising communicating with a transaction privacy clearing house (TPCH), to authorize a transaction without revealing the user's identity.

8. A method comprising:
reading security information from a magnetic stripe of a personal transaction card when the card is swiped through a device;
calculating a cryptogram using the security information;
writing the cryptogram to the magnetic stripe of the card with the device after a user takes possession of the card; and
authorizing a purchase upon verification of the cryptogram by an independent cryptogram verification source upon reading of the card at a transaction terminal.

9. The method of claim 8, further comprising authorizing access to the device by a security device.

10. The method of claim 8, wherein the independent cryptogram verification source is a transaction privacy clearing house (TPCH).

11. The method of claim 8, further comprising:
verifying that the cryptogram has been written to the card; and
receiving the card in the device for at least one additional swipe to read the data and write the cryptogram to the card if the verification fails.

12. The method of claim 8, further comprising:
sending a confirmation message to a display of the device to verify that the cryptogram has been written to the card.

13. The method of claim 8, wherein the transaction terminal is a point of sale terminal.

14. The method of claim 8, further comprising communicating with a transaction privacy clearing house (TPCH) to authorize a transaction without revealing the user's identity.

15. An apparatus comprising:
a device to calculate a cryptogram based upon a security information; and
a writer, coupled to the device, to write the cryptogram on a magnetic stripe of a personal transaction card after a user takes possession of the card.

16. The apparatus of claim 15, further comprising a secure processing unit coupled to the device to calculate the cryptogram.

17. The apparatus of claim 15, wherein the cryptogram is further based upon a current time.

18. The apparatus of claim 17, further comprising a secure time source coupled to the device to provide the current time.

19. The apparatus of claim 17, further comprising an interface with a secure time source coupled to the device to provide the current time.

20. The apparatus of claim 15, wherein the device is a personal transaction device.

21. The apparatus of claim 15, wherein the device is a hand-held, portable device.

22. The apparatus of claim 15, further comprising a reader coupled to the device to read existing data from the magnetic stripe.

23. The apparatus of claim 22, wherein the reader is built into the writer.

24. The apparatus of claim 15, further comprising a voiding component coupled to the device to void the cryptogram after the expiration of some time period.

25. The apparatus of claim 15, wherein the writer is externally located from the device.

26. The apparatus of claim 15, wherein the writer places an item of transaction data on the magnetic stripe.

27. The apparatus of claim 26, wherein the transaction data is selected from the group consisting of:
a current time;
an identification (ID) of an item to purchase;
a transaction amount limit; and
a transaction type restriction.

28. The apparatus of claim 15, wherein the security information is selected from the group consisting of:
biometric information;
existing data on the magnetic stripe;
a transaction amount; and
a personal identification number (PIN) code.

29. The apparatus of claim 15, wherein the device is selected from the group consisting of:
a privacy card;
a digital wallet; and
a privacy card configured to be coupled to a digital wallet.

30. The apparatus of claim 15, further comprising a security device coupled to the device to prevent unauthorized use of the device.

31. The apparatus of claim 30, wherein the security device is selected from the group consisting of:
a biometric security component; and
a keypad for personal identification number (PIN) code input.

32. The apparatus of claim 30, wherein the security device places a restriction on use of the device, the restriction selected from the group consisting of:
a transaction amount;
a transaction type; and
a user having authorization to use the device.

33. The apparatus of claim 15, wherein the cryptogram is a cryptographic hash value of the current time and the security information.

34. The apparatus of claim 33, wherein a key is used in calculating of the cryptographic hash value.

35. The apparatus of claim 34, wherein the key is selected from the group consisting of:
a symmetric key;
a private key; and
a secret key.

36. The apparatus of claim 15, further comprising a transaction privacy clearing house (TPCH), coupled to the device when a transaction is to be performed, to authorize the transaction based upon verification of the cryptogram.

37. The apparatus of claim 36, wherein the TPCH independently computes the cryptogram and verifies the cryptogram on the card.

38. The apparatus of claim 36, wherein the TPCH is further configured to selectively couple to a financial institution.

39. The apparatus of claim 36, wherein the TPCH further comprises a financial institution.

40. The apparatus of claim 15, further comprising a transaction terminal configured to couple to the device.

41. The apparatus of claim 40, wherein the transaction terminal is selected from the group further consisting of:
a point of sale (POS) terminal;
a home computer system;
a bank automatic teller machine (ATM) terminal;
a digital television; and
a personal POS terminal.

42. The apparatus of claim 36, further comprising a transaction terminal configured to couple to the device.

43. The apparatus of claim 42, wherein the transaction terminal, the device and the TPCH are further configured to verify each other as legitimate.

44. An apparatus comprising:
a device to calculate a cryptogram based upon a security information, the device further having a device identifier that provides no apparent identification of a user authorized to use the device;
a writer, coupled to the device, to write the cryptogram on a magnetic stripe of a personal transaction card after a user takes possession of the card;
a communication logic coupled to the device configured to communicate the device identifier and the cryptogram to a system to perform a transaction, the system comprising a secure mechanism for correlating the cryptogram, device identifier and the user; and
a security logic coupled to the device configured to allow an authorized user to use the device to perform a transaction based upon verification of the cryptogram by the system.

45. The apparatus of claim 44, wherein the security logic confirms a user of the device, the security logic selected from the group consisting of:
the cryptogram;
a personal identification number (PIN) code;
a biometric information; and
a transaction amount.

46. The apparatus of claim 44, wherein the communication logic is selected from the group consisting of:
an IC card interface;
a contactless connection;
a magnetic stripe; and
a wireless connection.

47. The apparatus of claim 44, further comprising a transaction history storage area coupled to the device and configured to store transaction records.

48. The apparatus of claim 44, further comprising a financial data storage area coupled to the device and configured to store information selected from the group consisting of electronic coupons, account balances and other data used during a transaction.

49. The apparatus of claim 44, wherein the communication logic is configured to accept direct marketing information.

50. The apparatus of claim 44, further comprising a transaction privacy clearing house (TPCH), coupled to the device when a transaction is to be performed to authorize the transaction based upon verification of the cryptogram.

51. An apparatus comprising:
a computing means for calculating a cryptogram from security information;
a writing means coupled to the computing means for writing the cryptogram to a magnetic stripe of a personal transaction card after a user takes possession of the card; and
a verifying means coupled to the computing means for verifying the cryptogram at a time of a transaction.

52. The apparatus of claim 51, further comprising a reading means coupled to the writing means for reading the security information from the magnetic stripe of a personal transaction card.

53. The apparatus of claim 51, further comprising a transaction privacy clearing house (TPCH), coupled to the computing means when a transaction is to be performed to authorize a transaction based upon verification of the cryptogram.

54. A machine-readable medium having stored thereon a plurality of instructions, which if executed by a machine, cause the machine to perform a method comprising:
calculating a cryptogram based upon security information; and
writing the cryptogram on a magnetic stripe of a personal transaction card after a user takes possession of the card.

55. The machine-readable medium of claim 54, wherein the method further comprises reading the security information from the magnetic stripe of the personal transaction card.

56. The machine-readable medium of claim 54, wherein the method further comprises verifying the cryptogram by comparing it against a cryptogram generated by an independent cryptogram verification source.

57. The machine-readable medium of claim 56, wherein the method further comprises authorizing a transaction based upon the verifying of the cryptogram.

58. The machine-readable medium of claim 54, wherein the method further comprises communicating with a transaction privacy clearing house (TPCH) to authorize a transaction without revealing the user's identity.
